(19) United States
(12) Patent Application Publication
(10) Pub. No.: US 2018/0355838 A1
(43) Pub. Date: Dec. 13, 2018

(54) GENERATING ENERGY BY MEANS OF AUTARCHIC TYPE 2.1 TO TYPE 4.1 HYDROELECTRIC POWER PLANTS

(71) Applicant: Hans-Jurgen Mueller, Wetzlar (DE)

(72) Inventor: Hans-Jurgen Mueller, Wetzlar (DE)

(21) Appl. No.: 15/764,472

(22) PCT Filed: Feb. 16, 2016
(86) PCT No.: PCT/DE2016/000057

§ 371 Date: Aug. 21, 2018

(30) Foreign Application Priority Data
Sep. 29, 2015 (DE) PCT/DE2015/000479

(51) Int. Cl. F03B 17/00; F03B 17/06

(52) U.S. Cl. CPC F03B 17/005; F03B 17/06

(57) ABSTRACT

The autarchic type-2.1 to type 4.1 hydroelectric power plants describe a method that extremely efficiently combines with one another the elements and assemblies that have been functioning for decades and, as it were, uses the gravity of the atmosphere, or rather the air pressure, at approx. 1.0 bar, as the main driving force for generating energy. Unlike solar energy and wind energy, the weight of the atmosphere is permanently available 24 hours a day and therefore can generate additional energy around the clock. The siphon principle involved in this method was used in Germany as early as 1927 for surface water transport in construction work and has been used since approximately 1900 to conduct water into lower collecting containers. In the method according to the invention, by using the atmospheric pressure as the driving force, the drop height for the generation of energy at a water turbine is generated by way of the siphon principle and by efficient pump units. It is thus possible that after deducting the energy needs of the pumps used, with type 4.1, for example, 16 units can produce a free and significant generation of energy for about 750,000 people, or for industry. The type-2.1 to type 4.1 plants can be installed above-ground or partially below-ground, depending on soil conditions, in all countries of the world and at costs that will amortize within a short period of time.

### 1. INTRODUCTORY REMARK

The previously registered methods of autonomous hydropower plants—‘type 2’ from PCT/DE2015/000002, ‘type 3’ from PCT/DE2015/000430 and ‘type 4’ from PCT/DE2015/000479—are combined in a uniform patent application on account of an absolutely identical addition in all three variants of the lifting systems and are distinguished by the addition “.1”. Only the system-relevant values of type 4.1 are numbered and calculated as characteristic values since differing values with respect to smaller and even larger plants are described in the patent claims.

The difference between the 3 plants is in performance, so type 2.1 is conceived for small plants, type 3.1 is conceived for small towns and small-scale industry, and type 4.1 is conceived for average cities up to 750,000 inhabitants, but can also find application in large-scale industry.

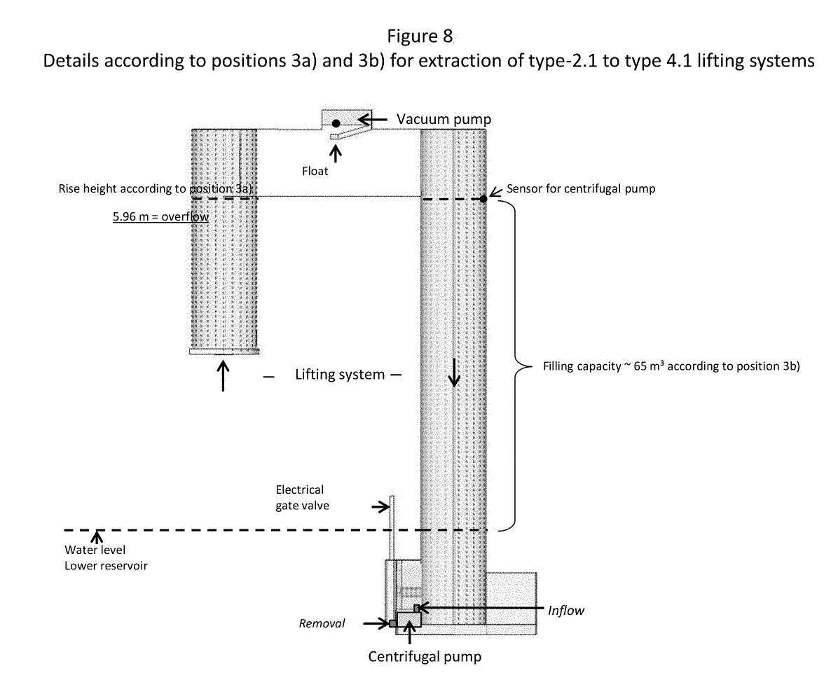

The patent specification contains the essential texts of the type 2 to type 4 patent specifications and the specific features which arise from the identical additions in the case of the three variants of the lifting systems and are represented explicitly in FIG. 8/8. The addition to the system enables precise and synchronous operation of the lifting line via the inflow of the propeller pumps so that a sensor can precisely regulate the water level in the upper reservoir by means of the management system.

### 2. INTRODUCTION

The advantageous combination of individual groups in a coordinated process results in a high and cost-free energy yield, which, depending on the solar power and wind power, is ultimately only generated via the gravity of the surrounding atmosphere, through an atmospheric air pressure of 1.0 bar.

The advantage lies primarily in the fact that air pressure, unlike in the case of the production of wind and solar power, is not dependent on constantly changing conditions; rather, the atmosphere with its weight is continuously and almost constantly available to the system 24 hours, day and night.

The mode of operation of the system is very simple, and the technology has matured over decades and can be used everywhere. Due to its physical and practical uniqueness, nothing can stand in the way of its recognition.

The system essentially consists of three main groups: a water-pumping system having high-efficiency pump assemblies, a water-lifting plant with cost-free use of air pressure and the supply of water flow to a self-explanatory pipe turbine system, which makes hydropower available via a generator transformer unit to generate power for intrinsic electricity and to produce energy for feeding into the power grid.

As a key requirement, the difference in height and the type of pump must be selected in such a way that the optimum operating point and the optimised pump performance thereby keep the relevant internal electricity demand as low as possible for the return of the water to the extraction reservoir of the lifting line.

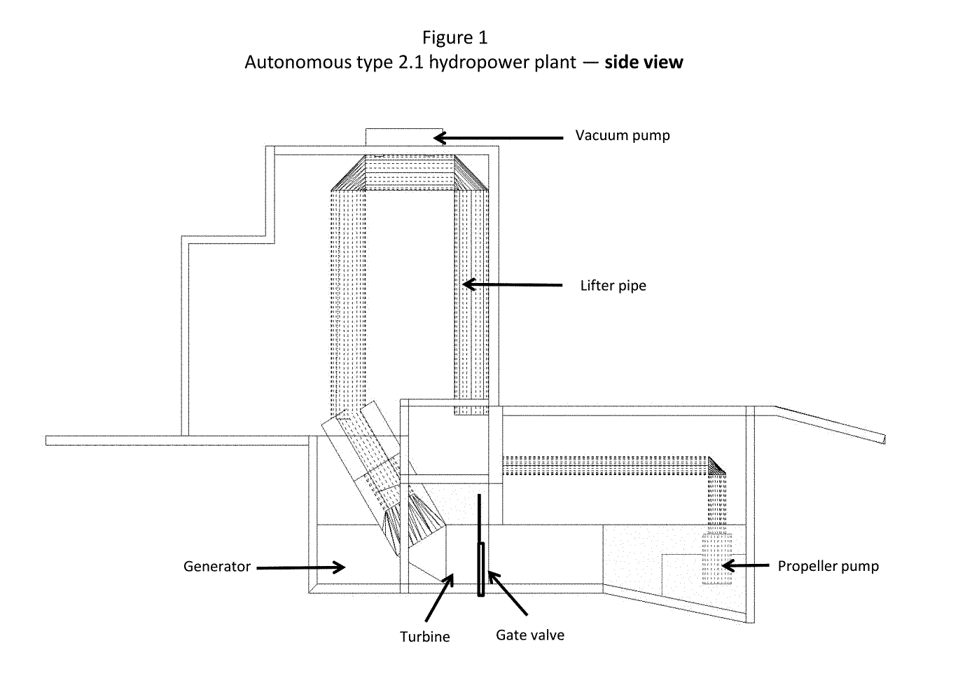

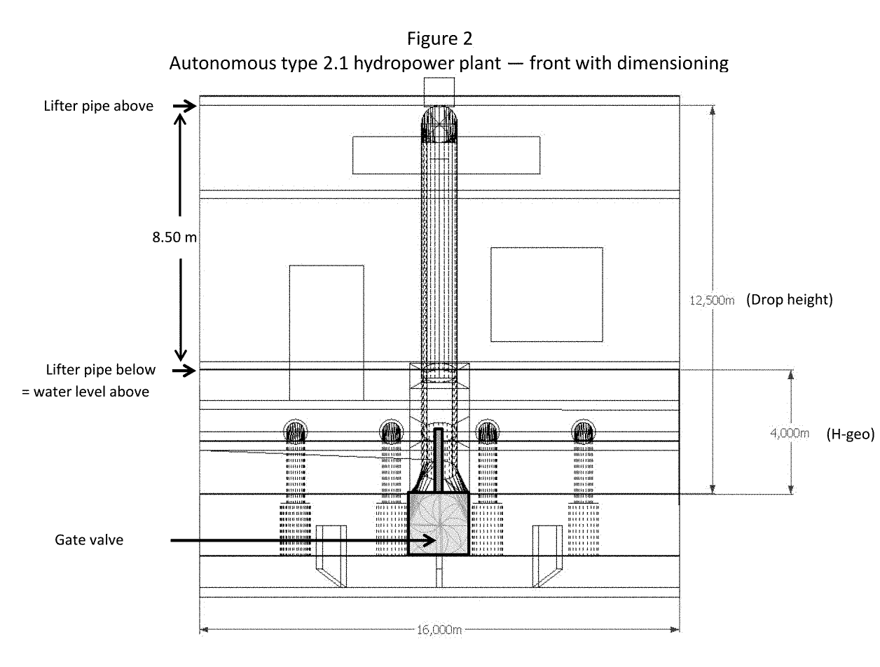

FIGS. 1/8 to 6/8 show the arrangement of the assemblies of the 3 variants, in which they are labelled with the most important designations.

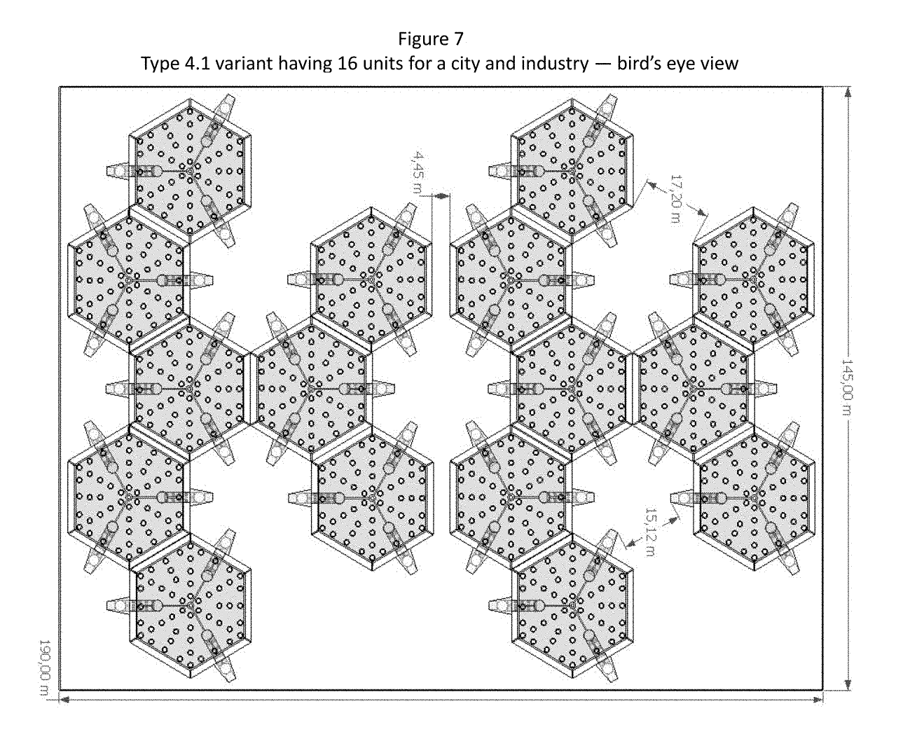

FIG. 7/8 shows a bird's eye view of the type 4.1 large-scale plant with the relevant dimensioning. Finally,

FIG. 8/8 shows the additional units, added in all three variants, of the lifting system as a detail according to positions 3a) and 3b).

The individual assemblies are described briefly and informatively below in terms of their function or roles.

### 3. DESCRIPTION

The mode of operation of the plant to be patented here is to be understood as a circuit using the weight of the atmosphere of 10 N (Newtons) per cm² as a driving force on the one hand and the gravitational force of water on the other hand. The only thing that really matters, is to create a large height difference between the mentioned line sections since a greater height difference results in a greater drop height to the turbine and, as a result, in contrast to other ecological methods, substantially higher power generation can be realised. The greater the height difference, the more water of a water stream can flow through the system in the same time period, wherein the described driving force of 10 N per cm² is converted from potential energy into kinetic energy in the lifting system. Consequently, an external force is set in motion and the first law of thermodynamics is not jeopardised; the system is thus not perpetual motion.

As a prerequisite for lifting system activation that functions smoothly and synchronously with all pumps, this patent application also documents that before the lifting system is commissioned, the descending outflow lifting line section is closed upstream of the turbine outlet in the lower reservoir by means of an electrical gate valve controlled by the computer management system. The vertically operating shut-off sluice is relatively easily installed at the edge of the lower inner reservoir. These sluices are industrially available with up to 4 bar water pressure (=40 metres of water column) and up to DN 3200. In the type 4.1 example, we require the dimension DN 2550. There are two variants for extracting the lifter pipe:

a) All the air within the line system is extracted provided that the connecting piece of the inflow lifting section in the upper reservoir remains constantly under water and air intake is prevented. This means that, after closing the shut-off sluice, the management system activates the pump management system for water pumping so that a constant water level can be generated and continuously regulated via a sensor in the upper reservoir for extraction—as described in the further patent specification. During the air extraction process, water in the inflow lifting section will flow from a rise height of 5.96 m (absolute 8.50 m), via the upper connecting section between the inflow and outflow lifting line into the outflow lifting section and fill the latter, since the closed sluice prevents outflow into the lower reservoir. On account of the air present in the line system, the water level can rise unimpeded in the outflow lifting section during extraction, so complete venting of the entire lifting line is possible by means of the overflowing water and the vacuum venting itself. In variant a), the water to be filled comes out of the upper reservoir. The required extraction time is given from the inflow (8.50 m), the connecting piece between the inflow and outflow (7.50 m) and the outflow (15.30 m), i.e. the total length of 31.3 m and the line dimension of DN 2540=158.6 m³ of air which is to be evacuated. It should be noted that it is widely believed to be incorrect that an extraction of very large quantities of air would be very energy-intensive. Modern vacuum pumps such as, for example, the claw vacuum pump, operate contract-free and without operating fluids and today achieve up to 60-percent energy savings with the same suction capacity, which was still considered inconceivable several years ago. The intended vacuum pump, with water equipment and float pulse generator, requires an extraction time of around 2.85 hours with a vacuum pump to extract 158.6 m³ according to the resulting lower effective suction capacity: S(eff)=V/tx ln (p[Start]/p[end]) with approximately 100 mbar final pressure=900 mbar dp and 3.5 kWh drive.

The intended use of two vacuum pumps for halving the air extraction time and for ensuring function in the event of a pump failing means that, ultimately, 1.43 hours are lost before the start of the lifters.

b) In the second variant, an external centrifugal pump (200-150-250) is used with the sluice also closed, which pumps the lower reservoir water into the lifter pipe up to the lower edge of the transition piece of the inlet and outlet. Consequently, when the vacuum pump is still switched off, water cannot run via the inflow into the upper reservoir. The advantage of this variant lies in the shortened air extraction time, whereas the disadvantage is in the acquisition and maintenance costs of the pump. A suitable centrifugal pump having, for example, 120 l/s requires only 9 minutes in the case of type 4.1 for the 64.7 m³ of water (from the water level of the lower reservoir to the lower edge of the connection region, 15.3 m minus DN 2.54 m=12.79 m) in the case of a power consumption of 2.88 kWh. Of course, the connections on both sides of the pump are secured to the lower reservoir and to the intermediate piece between the turbine and lifter pipe by 100-percent pressure-tight valves, which even after the pump has been switched off, ensure absolute pressure tightness against infiltration or exfiltration emergences. Furthermore, an additional sensor is mounted on the inner edge of the lifter pipe section, which stops the centrifugal pump when the required filling level is reached, via an automatic signal to the management system and initiates the start of the two vacuum pumps in the upper lifter pipe region.

The air extraction time in variant b) is calculated from the remaining air volume, the inlet=8.50 m and the connecting piece from the inflow and outlet=7.50 m, plus the dimension of the outlet, since the water is only filled up to the lower edge=2.54 m, i.e. the total length 18.54 m, the dimension DN 2540, which gives a volume of 94 m³. The air extraction time is thus 1.81 hours for a vacuum pump and, as in the case of a), for two connected vacuum pumps, is 55 minutes. The 9 minutes of filling the outlet lifter pipe with water has to be added to this time, so 64 minutes (1.04 hours) are required in the case of b).

Summary for extracting the lifting system:

a) The lifter pipe is vented in 1.43 hours with 9.98 kWh of pump energy consumption.

b) The lifter pipe with the additional centrifugal pump is vented in 1.04 hours with 9.22 kWh.

A further shortening of the air extraction time would be possible in both cases by increasing the power of the pumps, wherein the size, the weight and the consumption have to be taken into account. The final process applies to both variants: As soon as the filling height is reached at 8.50 metres from the water level of the upper reservoir to the inner upper edge of the upper connection, the float sends a signal to the management system to switch off the vacuum pumps so that, without delay, there is a start to the process, controlled by the management system, of precisely lifting the butterfly valve for the parallel and synchronous power increase of the propeller pumps. This process is completed in a material-preserving manner after about 2-3 minutes. The synchronous control increases the water flow proportionally and constantly to generate energy—up to the maximum flow of water. Regulation of the butterfly valve by the management system also has the advantage that, in the event of a propeller pump failing, the water flow can be reduced by software so that, in the case of power balancing, unnecessary loading of other pumps is avoided until maintenance, and the system can generally be powered down in an optimally controlled manner prior to maintenance work.

Finally, a remark to the widespread opinion that the extraction of air molecules accumulating from time to time in the upper line section of the pipeline during operation is high and that a maximum energy consumption of 20 kWh per day cannot be achieved. Only the above-mentioned means of energy determination for the ventilation a) with 158.6 m³ of air should arguably suffice for stationary and fully pressure-tight plants. On the construction site (Berlin, 1927) which is mentioned in point 5 below, only a few kilowatt hours were demonstrably required for “constant venting” of the system, for 50 million cubic metres of water (“Mitteilungen der Polytechnischen Gesellschaft” 1927, page 251). The fact that the low energy requirement from 1927 can be further and considerably reduced about 89 years later is, however, undisputed.

### 4. BASIC INFORMATION ON LIFTER PIPE SYSTEMS

Large lifter pipe systems were already implemented with impressive pipeline cross-sections from 1905 at the Los Angeles Aqueduct and in 1927 in a construction project in Berlin.

The dimensions of the lifter pipelines—in America up to 3.05 m (DN 3050) and in Berlin with 2-fold parallel 1.5 m (DN 1500) and DN 800 lines—are clear proof of the major role and possibilities of this application. The lifting systems are very efficient, but are still underestimated to this day in terms of their development potential, and thus the resources in this respect remain largely unused. Using the capabilities of vacuum technology at the time for venting large pipelines and for the holding vacuum, water could be lifted up to approximately 7.50 m in construction projects, and with today's technology can be lifted up to 8.50 m of the height difference, and subsequently transported into a lower region without any significant energy consumption.

To explain the lifting performance, it should be pointed out that the theoretical suction height at an air pressure of 1013 hPa and 4 degrees, with respect to the sea level height of the region, is reduced by a loss of 12 cm per 100 metres of height. Furthermore, losses arise due to the effect of weather, with a loss of up to 50 cm owing to steam formation and the specific water temperature in the plant. Type 2.1 to type 4.1 plants are located approximately 50 percent below the earth's surface, and thus the assumption of a temperature of approximately 17 degrees Celsius is justified, so the suction height is reduced by a further 21 cm. Finally, approximately 10 percent must be taken into account for flow losses even in the case of large dimensions and a professional stationary plant. In total, the theoretical initial height of 10.33 m is therefore reduced for type 2.1 to type 4.1 plants by a total of approximately 1.52 m, so the practical suction height of 8.81 m for my calculation assumption of 8.50 m has an additional safety margin of approximately 30 cm.

The energy consumption for the vacuum pump, today as back then, is required only for pumping out air and for the automatic operating state during plant operation (see section 3). Power consumption nowadays is at a low 10 to 20 kWh during operation for these dimensions and modern vacuum pumps, depending on whether there is a stationary or mobile design. It should be noted again that a permanent suction of the vacuum pumps is only required for completely venting the lifter pipe until water flows independently. Furthermore, only automatic venting of air molecules is needed which are carried by the system from ambient air which are lighter than water and in principle collect at the highest point in a pipeline system. For type 2.1 to type 4.1 plants, two vacuum pumps are arranged on the upper horizontally reinforced lifting section, which can be accessed for maintenance work via the roof. Both are in operation during the air-suction phase after which one pump takes over the automatic operational stand-by mode or the removal of small air entrainments from the water flow so that the second pump can serve as a reserve pump or as an active support.

### 5. POWER REQUIREMENTS AND PERFORMANCE DETERMINATION OF THE PLANT

The lifter water flow of the plant is determined on the basis of the following formula:

$$Q = 1.25 \times {10}^{4} \times {d}^{2} \times \sqrt{\begin{matrix}\frac{e}{1} \\ + δ\end{matrix}}$$

Q=quantity of water, d²=dimension in m, e=H-geo and 1+resistance or pressure loss.

Based on the example of the type 4.1 plant, the following water volume to be moved was determined on the basis of the exemplary estimate for a compact plant having 6 sub-areas, each having 9 pump assemblies (=54 pumps).

### Estimates:

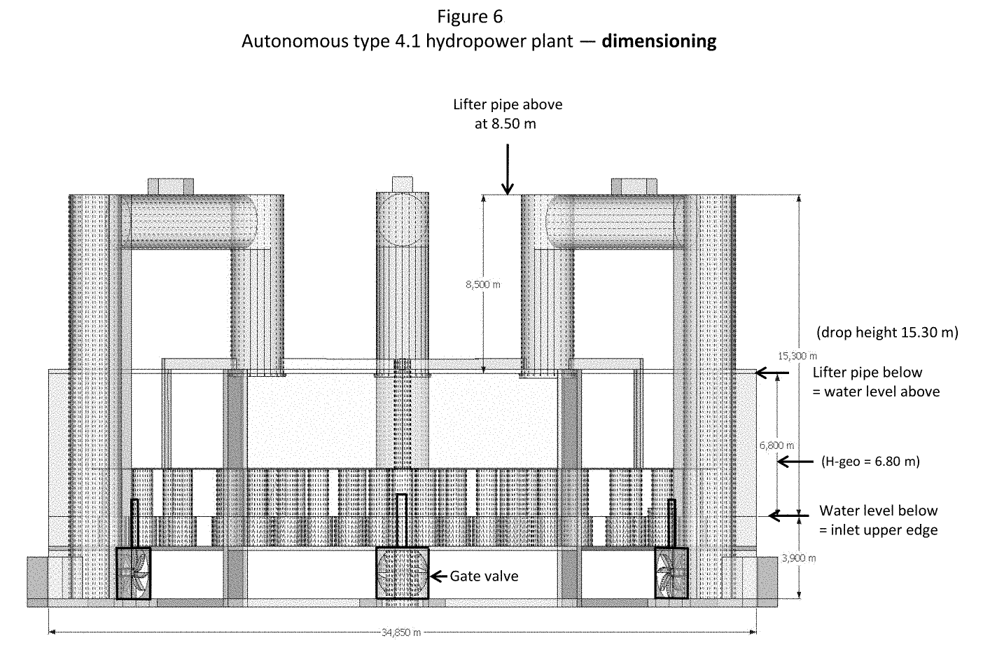

H-geo=6.80 m (FIG. 6/8) corresponds to the difference between the two upper and lower water levels, wherein the circulating quantity of water is pumped to the higher level by means of the pump assemblies. The estimate of the quantity of water for the type 4.1 plant is divided into three sub-regions a′ 57.96 m³ water per second and, in terms of the dimensions for the large-scale plant, is increased by an approximately 3-fold quantity of water so that for each type 4.1 plant unit, 3 lifting systems a′ 57.96 m³, with a total water quantity of 173.9 m³ per second, are used.

According to the above formula, an estimated pump line dimension is calculated for the 54 pump lines of the 54 pump assemblies, which, adapted from the pump body through the riser pipes according to the system, has been rounded up to 1.0 m (DN 1000). The three lifting systems will deliver a total water quantity of 626,040 m³ per hour to the three water turbines via the three riser pipes in three descending lifter pipes. According to the same formula as presented, the calculation thus, gives a dimension of 2.54 m (DN 2540) for the three lifting systems. The frictional losses of the water transport to the turbine are relatively low in the case of larger dimensions. Irrespective of this, a safety margin of up to DN 2550 can be provided for the dimensional calculation so that, if necessary, a greater water flow is also possible. Especially against the background, that the pump performance can be continuously regulated and adjusted up and down via a pump management system and a water level sensor. This means that the sensor and the controller ultimately regulate the required amount of water for the lifter systems in the upper reservoir so that no air can enter the lifter systems. A second water level sensor regulates the starting point for the lower limit in the lower reservoir from when a determined evaporation rate of the water from a separate water container is compensated via a water pipeline connection or a well with controller. Via a determined minimum water level, the sensor thus transmits the signal to the pump management system for a limited and external inflow of water.

### 6. PUMP ASSEMBLIES

The pump assemblies of the leading manufacturers are similar and self-explanatory, so I only had to choose the most efficient propeller pump on the world market with the lowest power consumption for the calculation of the water circuit, with respect to the parameters of the type 4.1 plant. A comparison was made of three equivalent companies which produce excellent units which can pump a water quantity in each case of 3.22 m³ of water per second, for a H-geo height difference of 6.80 metres and a similar power consumption. The relevant products of the companies, independent of one another, are capable of pumping a water quantity of 57.96 m³ per second with a power consumption of approximately 252.0 kWh×18=4536 kWh for each of the 3 lifting systems, each having 18 pumps, so that the calculation for the intrinsic power consumption can be considered reliable and guaranteed.

### 7. PIPE TURBINE WITH CONNECTED GENERATOR

This unit is also largely self-explanatory in its function, so I can restrict myself to the most important details concerning its use. Crucially, it should be borne in mind that this type of turbine can also be placed horizontally, so to speak on the floor of the plant. This does not result in unnecessary height losses, which would be the result from a deeper construction pit. There are excellent specialists in Germany and in Austria, who can guarantee the expected amount of power generation based on the function of the quantity of water and the drop height according to the laws of physics. The calculation can be done at any time by computer online by means of a small software tool.

For a type 4.1 unit having 3 lifting systems, a water quantity of 57.96×3=173.9 m³/s and a 15.3 metre drop height (dimensioning, FIG. 6/8) give us 3×7830 kWh=23,490 kWh of electricity for the three generators. Of course, this amount of electricity has to be subtracted from the internal power consumption, which is immediately available for the use of the pumps. This means that, minus the internal power consumption for the 54 pump assemblies and for the venting of the standby vacuum pumps, the sum of 3×4546 kW per hour has to be subtracted from the 3×7830 kW per hour generated by the three generators. Due to the necessary transformation of the generator current for supplying the grid, the value has to be reduced approximately by a further 3×66 kWh, so that, ultimately, an approximate total energy yield of 3×3218 kWh=9654 kWh for grid feed-in is available at each plant unit for further use or sale.

Although, in accordance with positions 3a) or b), the low “starting current” to be taken from the public grid or from the internal plants for the lifter pipes per unit with 3×9.98 kWh or 3×9.22 kW would have to be taken into account, around 30 kWh are not taken into account for the initial system start, since I have calculated 240 kWh×3 per day per unit, with 3 lifting systems, as additional internal consumption. Additional note: I already gave my opinion on the various views concerning the energy consumption of the vacuum pumps during continuous operation; however, I have already (in the past and in this document) estimated 20 kWh=60 kWh per day for each lifter pipe as the additional consumption for ‘continuous operation’. In the preceding paragraph, after subtracting the intrinsic consumption of all pumps, 4546 kW per hour was claimed although according to position 6, the intrinsic consumption of the propeller pumps requires only 4536 kW per hour (buffer=240 kWh/day and 720 kWh per unit/day). After subtracting the 30 kWh and 60 kWh/day, about 630 kWh per day per unit are left for the entire plant control system, the management system, for the power consumption of the switch cabinets (pumps, generators, transformers), the PC systems, the prorated consumption for offices, light, etc., and for the security devices inside and outside the plants.

Final result: The presented system of a large-scale plant having 16 units in 2 sections a′ 8 units would in total generate a net energy yield of 154.464 MW per hour, 3,707.136 MW per day and about 1353 million MW per year, from 16 units×9654 kWh (=9654 MW).

Compared with an offshore plant commissioned in September 2015 in the Baltic Sea (Northern Germany) and operating at 1.2 billion kWh (=1200 million MW per year), the type 4.1 plant with an annual yield of 1353 million MW is clearly more powerful and this at 10% of the procurement costs for the offshore plant and at least twice the system runtime. The reservoirs of all the type 2.1 to 4.1 plants are designed to last according to the water-impermeable reinforced concrete construction principle, so that only the bearings on the rotating components have to be serviced and replaced every 20 years, as a precaution, on account of the same operating and drinking water conditions.

### 8. OUTLOOK AND VARIANTS

Of course, the type 2.1 to type 4.1 plants can be designed with an even larger structural shape, including round, angular, square, ring-shaped, octagonal or polygonal, having more than 54 units, or fewer units but more powerful pumps. The dimension of the lifter pipe depends on the corresponding pump power, so a higher energy yield can be generated with a more powerful turbine and the corresponding generator. The second possibility would be to produce a greater drop height by means of a deeper construction pit or an elevation of the plant, which would provide an even higher electricity yield with the same number of units and therefore higher internal power consumption of the pumps. This variant remains reserved to those areas which have a suitable foundation site or for plants which are higher above the foundation sites and which enable or allow an elevation in industrial halls or, as per the development plan, in commercial or industrial areas. In the case of elevated plants, the boundary conditions for the performance of the pumps should also be checked according to positions 3a) or 3b).

1.-14. (canceled)

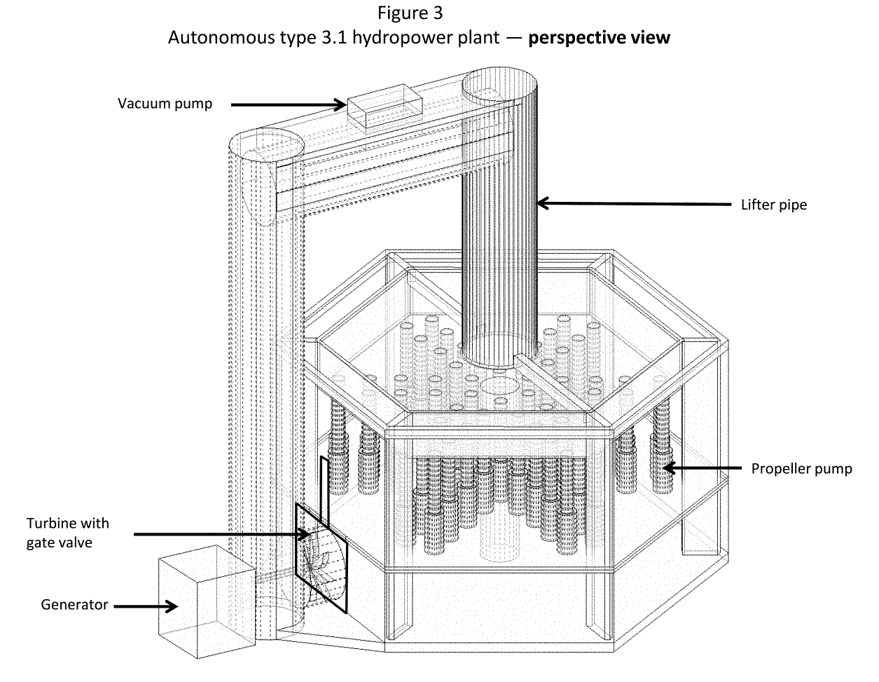

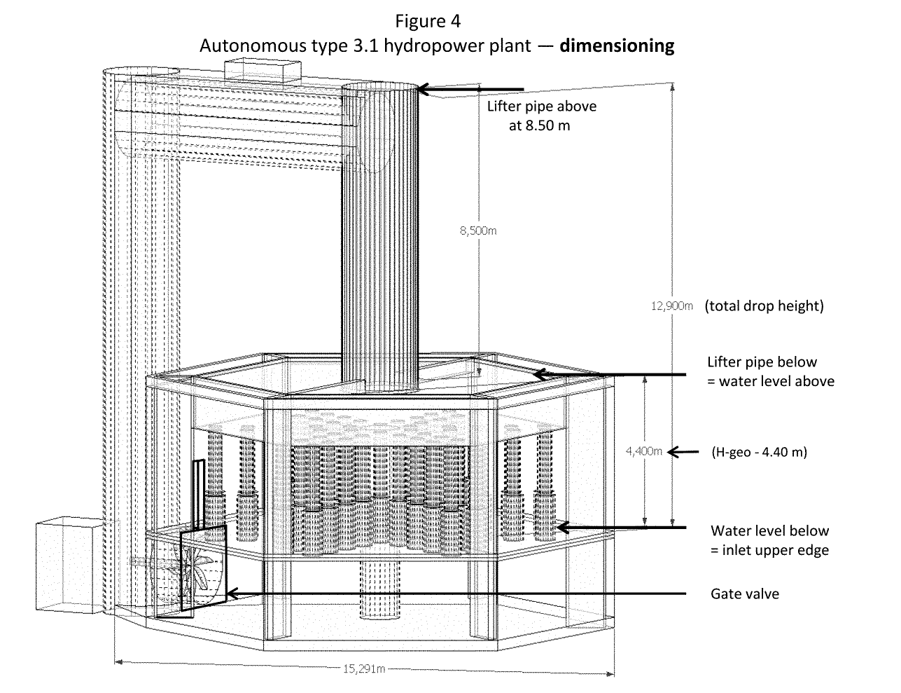

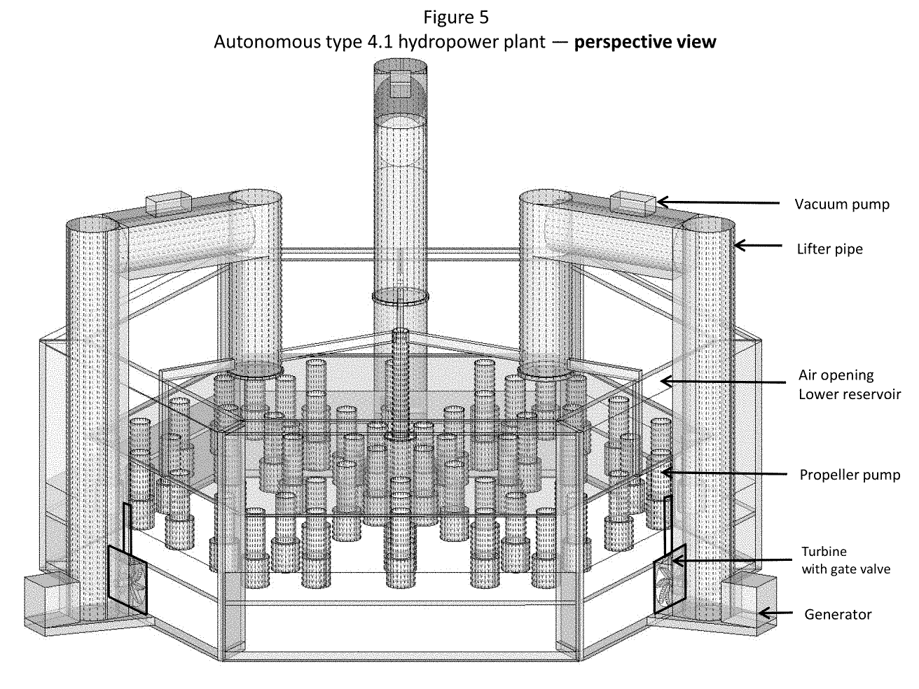

15. An autonomous hydropower plant, comprising energy being generated by means of at least one lifting system (type 2.1 FIG. 1; type 3.1 FIG. 3; type 4.1 FIG. 5) and by means of a water recirculation (type 2.1 FIG. 1; type 3.1 FIG. 3; type 4.1 FIG. 5).

16. The autonomous hydropower plant according to claim 1, further comprising a water circuit having a combination of
a pump assembly (type 2.1 FIG. 1; type 3.1 FIG. 3; type 4.1 FIG. 5),
at least one lifting system with vacuum ventilation (type 2.1, FIG. 1; type 3.1, FIG. 3; type 4.1, FIG. 5), and
discharge of the water flow via a water-turbine and generator combination (type 2.1, FIG. 1; type 3.1, FIG. 3; type 4.1, FIG. 5);
wherein an energy yield is achieved.

17. The autonomous hydropower plant according to claim 1 wherein the plant has 16 units arranged according to the preceding claim in a hexagonal form, and that the drop height is 15.30 m (type 4.1, FIG. 7).

18. The autonomous hydropower plant according to claim 1 wherein, by means of a deeper construction pit (p. 9, No. 8) or by means of an above-ground elevation of the plant, a greater drop height than 15.30 m to the water turbine is achieved.

19. The autonomous hydropower plant according to according to claim 1 wherein the plant is arranged in a ring-shaped or octagonal or as a polygon (p. 9, No. 8);
wherein the turbine is designed to be larger or smaller in accordance with the number of pump assemblies; and
wherein the water inflow can take place from below or sideways, depending on the size of the reservoir or container.

20. The autonomous hydropower plant according to claim 1 wherein there are 54 pump assemblies (p. 9, No. 8).

21. The autonomous hydropower plant according to claim 1 wherein the pipe dimensions of the inflow lines, of the lifting lines and of the outflow lines depend on the quantity of water.

22. The autonomous hydropower plant according to claim 1, further comprising:
a shut-off valve upstream of the turbine;
a water inflow up to the connecting piece of the inlet and outlet of the lifter pipe; and
an external or internal pump for evacuating the lifter pipe;
wherein the shut-off valve is controlled by a management system; and
wherein the extraction of the lifter pipe takes place via the water inflow.

23. The autonomous hydropower plant according to claim 1 wherein the inlet height of the lifter pipe is adapted to the prevailing local air pressure and/or the local terrain height.

24. The autonomous hydropower plant according to claim 1, further comprising a gate valve which is controlled by a management system, said gate valve controls and regulates the start of extraction, synchronous operation of the lifter pipe and propeller pumps and vacuum pumps, the operation of the plant in the case of a pump failure, the water flow and the shutdown of the plant.

25. A method for operating an autonomous hydropower plant according to claim 1 wherein, before the vacuum pumps are commissioned, the gate valve is closed upstream of the turbine outlet;
the extraction of the lifter pipe occurs either via pure vacuum venting of the lifter pipe or by means of a separate water inflow to the lifter pipe section to the turbine;
the extraction is controlled by a signal, a sensor and a management system;
the gate valve is opened by a signal after the lifter pipe is extracted; and
the propeller pumps then continuously and synchronously increase their power up to the maximum.
